(19) United States
(12) Patent Application Publication
(10) Pub. No.: US 2006/0012095 A1
(43) Pub. Date: Jan. 19, 2006

(54) Method for production of a reaction rod for vehicles and said reaction rod

(76) Inventors: Sven Bjorkgard, Kongsberg (NO); Aleksander Kristoffersen, Darbu (NO)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/516,535

(22) PCT Filed: Jun. 5, 2003
(86) PCT No.: PCT/NO03/00184

§ 371 Date: Jul. 1, 2005

(30) Foreign Application Priority Data
Jun. 5, 2002 (NO) 200222664

(51) Int. Cl. B25B 1/20

(52) U.S. Cl. 269/40

(57) ABSTRACT

A method of manufacturing a reaction rod for use in connecting a chassis (21) of a vehicle with a wheel axle housing (22) of the vehicle. The reaction rod comprises a rod (1) with two end portions, two housings (2,3), each of which can be securely connected with its rod end portion, and two attachments pieces (8,9), each of which extends through its passage (4,5) of the housings (2,3). The attachment pieces (8,9) are arranged to be attached to the chassis (21) and the wheel axle housing (22) respectively. The distance between reference points (16,17) of the respective attachment pieces (8,9) establishes a functional length (F) of the reaction rod. The method comprises the steps of manufacturing the housings by stamping and bending of a plate, manufacturing the attachment pieces (8,9) with a clearance relative to the passages (4,5) inserting the attachment pieces (8,9) in the respective passages (4,5), mounting the attachment pieces (8,9) in a jig, the distance between the reference points (16,19) corresponding to the functional length (F), and attaching the housings (2,3) to the rod (1). A reaction rod with housing manufactured from a plate.

The invention relates to a method for manufacturing a reaction rod for connecting a chassis of a vehicle with a wheel axle housing of the vehicle, as indicated in the introduction to claim 1.

From EP 0 684 404 a reaction rod is known where the attachment pieces are provided with press fit relative to the passages. Inserting the attachment pieces with force fit in the passages results in tangential stresses in the housings. During operation of such a reaction rod, exceptionally high stress concentrations will occur at the portion of the housings located at the transition between the passages and the pins due to the press fit of the attachment pieces. The houses are therefore forged and the other connecting portions of the housings comprise solid pins arranged to be inserted in tubular end portions of the rod. This results in the reaction rod being heavy.

From DE 4 132 779 a reaction rod is known with a favourable weight to strength ratio.

To manufacture the known reaction rods, the attachment pieces and an assembly comprising the rod and the houses are fabricated separately. Care must be taken during this process to ensure that each of these components is manufactured with tolerances that ensure that a specifically defined distance between reference points or length of the finished reaction rod, a so-called functional length, has a value that is within a desired tolerance. This tolerance may typically be, e.g. ±0.5 mm. The reason for this is that when two reaction rods are employed, for example, it must be ensured that the wheel axle housing has a desired orientation relative to the chassis.

Since three components with tolerances have to be fabricated for each reaction rod, viz. a rod/housing assembly and two attachment pieces, and the tolerance for the functional length is obtained by an addition of the components' length tolerances, this method of manufacture is expensive. Furthermore, there is a risk of obtaining reaction rods with an incorrect functional length on account of the addition of the many tolerances, the risk that these tolerances may deviate from the correct value increasing with the number of components manufactured with tolerances.

In order to try to avoid having to reject reaction rods with incorrect functional length, after manufacture the reaction rods may be measured and classified according to length, since the use of reaction rods within the same length classification ensures the above-mentioned, desired orientation of the wheel axle housing in the chassis. To measure and classify the reaction rods in this manner is time-consuming, and in addition a separate storage place has to be provided for each length classification.

A second option is to place thin metal distance pieces or shims between the reaction rod and the chassis or wheel axle housing for compensation of an incorrect functional length. A disadvantage of this method is that a storage place must be made and provided for distance pieces, and the measurement, choice and adaptation of distance pieces during a reaction rod assembly is time-consuming.

Furthermore, from the international application PCT/DE99/01274 it is known that the length of the reaction rods may be adjustable. Even though the manufacture of the reaction rod's components according to tolerance measurements is hereby avoided, the measurement and adjustment of such reaction rods is time-consuming and the reaction rods are complicated and expensive.

The object of the invention is to provide a light-weight reaction rod which is manufactured by a method that is not encumbered by the above-mentioned drawbacks.

The characteristic of the invention will be apparent from the characterising features indicated in the claims.

The invention will now be described in greater detail with reference to the drawing which illustrates an embodiment of a reaction rod which has been manufactured by means of the method according to the invention.

FIG. 1 is a perspective view of a reaction rod.

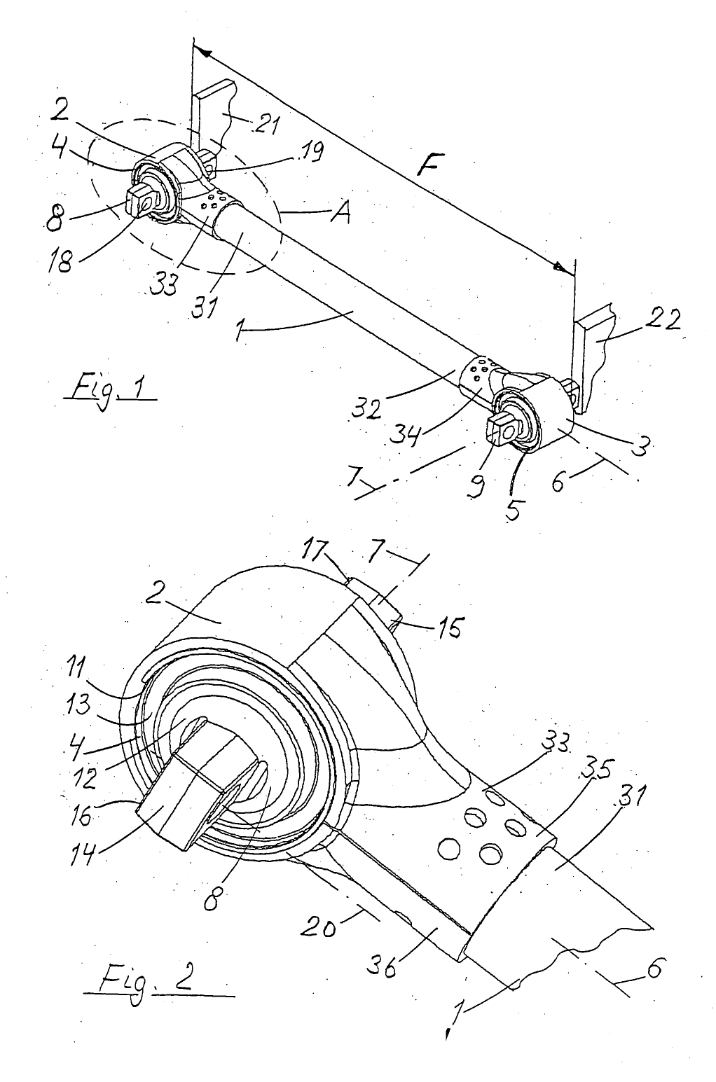

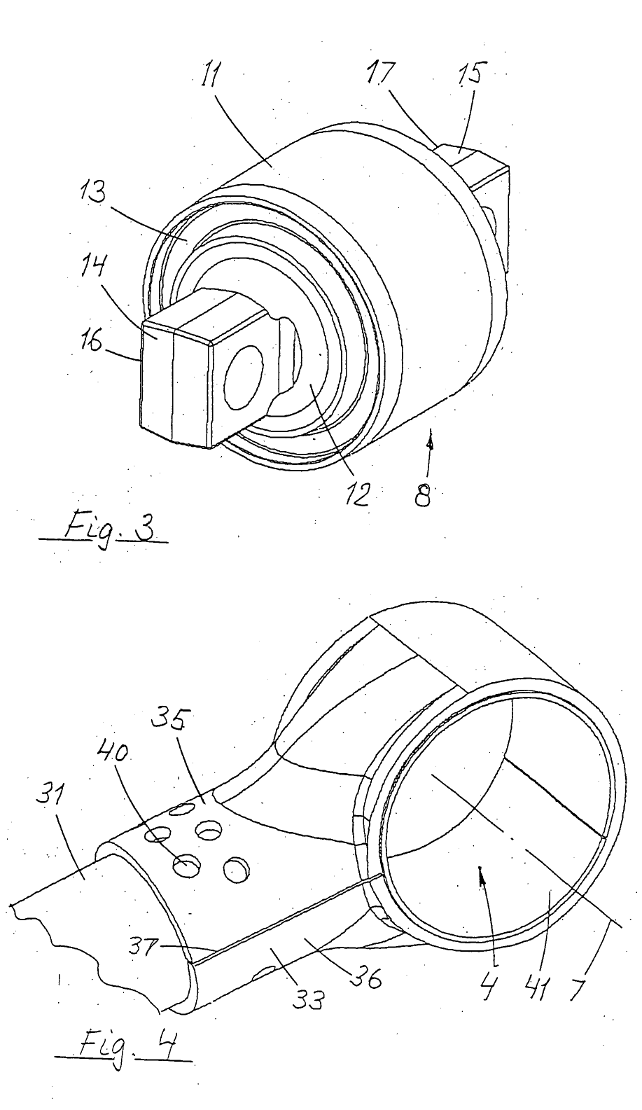

FIG. 2 is a perspective view of the end portion of the reaction rod indicated by A in FIG. 1, where an attachment piece has been inserted in a passage of a housing of the reaction rod.

FIG. 3 is a perspective view of an attachment piece like that illustrated in FIG. 2.

FIG. 4 is a perspective view of the reaction rod illustrated in FIG. 2, but where the attachment piece has been removed from the passage.

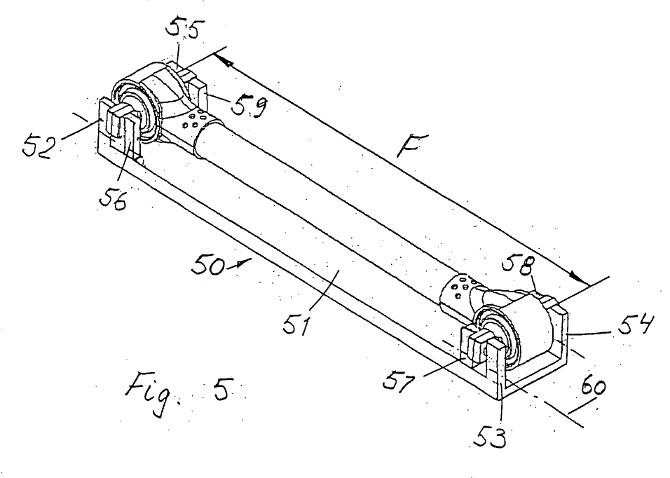

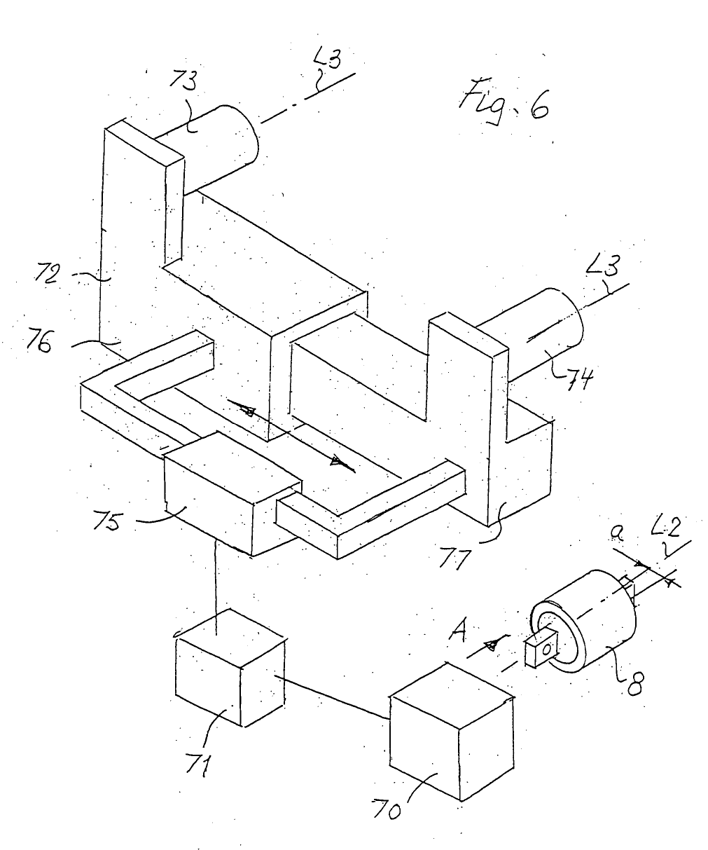

FIG. 5 is a schematic perspective view of a first jig wherein end portions of a reaction rod are secured, for use in a first variant of a method for manufacturing a reaction rod according to the invention.

FIG. 6 is a perspective view of a second jig for use during the execution of a second variant of a method according to the invention.

As can be seen in FIG. 1, the reaction rod comprises a central portion or a rod 1 and two heads or housings 2,3, which are securely connected to the rod 1 by respective end portions of the rod 1. The rod 1 may have a circular cross section and a longitudinal axis 6. Each housing 2,3 has a through-going passage 4,5 whose longitudinal axis 7 extends at an angle, e.g. 90° relative to the rod's longitudinal axis 6, this angle being dependent on how the reaction rod extends relative to the chassis and the wheel axle housing. The passages are preferably cylindrical and circular in cross section.

The reaction rod's end portions are substantially identical, and what is described below with reference to one end portion also applies to the second end portion.

As also illustrated in FIGS. 2 and 3, an attachment piece 8,9 is inserted in each passage 4,5.

At its central portion, each attachment piece 8,9 may comprise an outer, tubular casing 11 and between this casing 11 and a core 12 extending through the casing 11, there is mounted a rubber element 13, which is securely connected to the casing 11 and the core 12 in a suitable manner. The diameter of the casing 11 is adapted to the diameter of the related passage 4,5, thus enabling the casing 11 to be inserted in the passage 4,5 with a small clearance. Each of the cores 12 has two lugs 14,15 projecting from the central portion and on each side thereof along the attachment piece's longitudinal axis 7.

Each of the lugs 14,15 has an abutment surface 16,17 extending at an angle, e.g. 90° relative to the rod's longitudinal axis, depending on the reaction rod's position in the vehicle. These abutment surfaces form reference points, a functional length F of the reaction rod being defined as the distance between these reference surfaces of each housing. It will be appreciated that other locations of the attachment pieces forming the reference points for the functional length may be chosen instead.

The lugs 14,15 have holes 18 and 19 respectively through which can be passed respective bolts 20, which are indicated only by their longitudinal axis, for securing the attachment pieces 8,9 to a chassis 21 and a wheel axle housing 22 respectively of the vehicle.

As illustrated in FIGS. 1,2 and 4, the rod 1 has two end portions provided as first connecting portions 31,32, and each of the housings 2,3 has a second connecting portion 33,34, which is arranged to be securely connected to the respective first connecting portions 31,32.

In the illustrated embodiment, each of the housings' second connecting portions 33,34 is in the form of a cylindrical tube which is split preferably in its longitudinal direction by a slot 37 at two diametrically oppositely located points all the way to the respective passages 4,5, with the result that each housing has two cup-shaped portions or cups 35,36, which are semicircular in cross section and define a cylindrical space with a diameter corresponding to the rod's outer diameter. On account of this splitting, a certain amount of elasticity is obtained, thus enabling the semicircular cups to be moved towards or away from each other and be brought into close abutment against the first connecting portions. Since the first and second connecting portions are in the form of an elongated cylindrical pin and an elongated, cylindrical hole respectively, the possibility is offered of obtaining overlapping between the connecting portions in a simple manner as well as the possibility of a relative axial movement of the connecting portions before they are permanently interconnected.

During manufacture of the reaction rod, the attachment pieces 8,9, the housings 2,3 and the rod 1 are fabricated separately. During this process these parts do not need to be manufactured accurately in order to achieve a functional length with a particularly fine tolerance.

For interconnection of the reaction rod's components, the pairs of cups 35,36, i.e. the housings' second connecting portions 33,34 are pushed on to the rod's end portions, i.e. the first connecting portions 31,32. The elasticity of the housings contributes hereby to an easy insertion of the first connecting portions 31,32. Furthermore, the attachment pieces 8,9 are inserted in the respective passages of the housings with a small clearance between them.

The attachment pieces 8,9 are then placed in a jig 50 (FIG. 5). The jig 50 may, for example, have a bottom 51 on which is mounted a positioning device for the attachment pieces 8,9. This positioning device may comprise four pillars or supporting portions 52,53,54,55, which project up from the bottom 51, and against which the abutment surfaces 16,17 of the attachment pieces' lugs 14,15 can come into abutment. The positioning device may also comprise tension means such as four tension blocks 56,57,58,59, which may be mounted on the opposite side of the lugs relative to the abutment surfaces 16,17, and which by means of, e.g. screws can be pulled towards the respective pillars 52-55, thereby pressing the attachment pieces against them. The screws are represented in FIG. 5 only by a centre line 60 for one of them. The attachment pieces can thereby be secured in such a manner that the relative distance between their opposite abutment surfaces 16,17 exactly corresponds to the functional length F with the desired tolerance, with the rod 1 and the housings 2,3 able hereby to slide axially relative to each other and permit securing of the attachment pieces.

The housings 2,3 are then connected securely, i.e. rigidly with the rod 1 and the attachment pieces 8,9 connected securely with the housings 2,3 by means of a suitable means of attachment, e.g. by welding, soldering, adhesion, etc. This kind of secure or rigid connection of the attachment pieces with the housings provides a reinforcement of the housings. If welding is employed, a number of holes 40 can be provided in the second connecting portions of the housing for interconnection of the housings and the rod by plug welding.

If the housings are attached to the rod in a manner whereby there is a risk that the attachment pieces' rubber element can be damaged, e.g. by excessive heating, there may be provided in the passages and between the housings and the attachment pieces a sleeve-shaped lining 41 (FIG. 4) which is attached thereto, e.g. by means of an adhesive, thereby providing better heat insulation of the rubber element. In addition the sleeve can cover a possible opening facing radially inwards in the passage and defined by the cups 35,36 and the end of the rod, providing a reinforcement of the reaction rod at this point.

Since the attachment pieces do not have press fit relative to the passages, less strain is placed on the above-mentioned transition portion between the passages and the second connecting portions of the housings. The housings can therefore be produced by stamping, bending and/or pressing of a plate-shaped material, e.g. into the shape illustrated in the figures, and the weight of the housings can be substantially reduced. As illustrated, e.g., in FIG. 4, the housings' second connecting portions 33 can be composed of the two cups or halves 35,36, which after a stamping process form end portions thereof and extend at a great distance apart, but which after a bending of the plate to approximately a C-shape, extend near each other with only the small opening or gap 37. A housing of this kind made from a plate can comprise stamped or pressed portions which increase the rigidity of the housing. Even though these halves 35,36 in an uninfluenced state should define a cylindrical space with a diameter that is smaller than the diameter of the first connecting portions 31, the halves can be moved slightly away from each other, thus increasing the gap 37 due to the housing's elasticity, and permit reception of a first connecting portion 31. By assembling the reaction rod's components in the above-mentioned manner, the production can be considerably simplified and much less expensive. By means of the invention, therefore, a cheap, light-weight reaction rod is also provided which reduces the unsprung weight of the vehicle.

The casing of the attachment pieces and the housings can advantageously be provided with a relative clearance, thus enabling the attachment pieces to be displaced at an angle to each other when they have been mounted in the jig. Alternatively or in addition the connecting portions can be provided with such a clearance. By securing the attachment pieces correctly in the jig and using an attachment means that advantageously completely fills the clearances, e.g. an adhesive such as hardenable plastic, or a soldering agent, it can be ensured that the longitudinal axes 7 of the passages 4 extend parallel to each other and at the correct angle relative to the rod's longitudinal axis 6 in the finished reaction rod, e.g. perpendicular to the rod's longitudinal axis 6, in addition to which the reaction rod's components are securely interconnected and the length of the reaction rod is correct.

With the above-mentioned method there may be a risk of damage to the rubber element 13 if the housings 3,4 are attached to the rod 1 by welding.

In order to avoid damage of this kind, the method of manufacturing the rod can be as above with the following additional remarks, reference also being made here to FIG. 6.

The through-going passage 4,5 has a first longitudinal axis L1 extending through a centre point of the passage's cross section.

The two attachment pieces 8,9 have a second longitudinal axis L2 extending through a centre point of the attachment pieces' cross section.

The rod 1 and the housings 2,3 are assembled initially without being permanently interconnected. Initially, the attachment pieces 8,9 are not inserted in the passages 4,5.

The contour of each attachment piece is initially established in the direction of the second longitudinal axis L2 as indicated by the arrow A. For this purpose use may be made, for example, of a digital camera 70 connected to a computer 71.

Alternatively, mechanical sensors or the like may be employed which are similarly connected to the computer 71.

The contour is analysed in the computer 71 in order to establish the location of the centre point of the attachment pieces' contour, the computer 71 having a program that is suitable for this purpose.

The computer 71 then calculates the distance a between each attachment piece's 8,9 reference point 16,17 and centre point, considered in the direction of the attachment piece 8,9 which coincides with the finished reaction rod's longitudinal direction. The rod 1 with the housings 2,3 is then mounted in a jig 72 with two parallel insertion pieces 73,74, whose cross section is adapted to the cross section of the passages 4,5, and each of which has third longitudinal axes L3 extending through the centre point of the respective insertion pieces' cross section, the insertion pieces 73,74 being inserted in the respective passages 4,5. The insertion pieces 73,74 may be conical and inserted in the passages until they just touch the passage walls.

The distance between the third longitudinal axes L3 of the insertion pieces in the housings is then adjusted by means of an actuator 75, which is arranged to move relatively telescopically connected portions 76,77 of the jig in relation to each other in such a manner that the distance between the third longitudinal axes L3 corresponds to the distance between the second longitudinal axes L2 when the reference points are at a relative distance corresponding to the functional length F. The actuator 75 is advantageously connected to the computer 71, thus enabling analysis values from the optical measurement concerning the distance a to directly influence a movement of the jig's insertion pieces 73,74.

The housings 2,3 are then connected with the rod 1 and the attachment pieces 8,9 are finally inserted in the respective passages 4,5 where they are fixed, for example, by means of an adhesive.

1. A method for manufacturing a reaction rod for use in connecting a chassis (21) of a vehicle with a wheel axle housing (22) of the vehicle, where the reaction rod comprises
a rod-shaped central portion or rod (1) with two end portions, each with its first connecting portion (31,32),
two housings (2,3), each with its second connecting portion (33,34), which can be rigidly connected with the respective, first connecting portions (31,32), and each housing (2,3) has a through-going passage (4,5), and
two attachment pieces (8,9), each of which extends through its passage (4,5), and which on use of the reaction rod can be attached to the chassis (21) and the wheel axle housing (22) respectively,
where the distance between reference points (16,17) of the respective attachment pieces (8,9) establishes a functional length (F) of the reaction rod,
where the rod (1) and the housings (2,3) are initially assembled without being permanently interconnected, and the attachment pieces (8,9) are inserted in the respective housings (2,3),
characterised by the following steps;
mounting the rod (1) and the attachment pieces (8,9) in a jig (50) with a positioning device (52-60) thereby securing the attachment pieces (8,9), the distance between the reference points (16,19) corresponding to the functional length (F), and
attaching the housings (2,3) to the rod (1).

2. A method according to claim 1,
characterised by inserting a heat-insulating lining (41) in the passages (4,5) between the housings (2,3) and the attachment pieces (8,9), and attaching the lining rigidly thereto.

3. A method according to claim 1 or 2,
characterised by providing the attachment pieces (8,9) and the respective passages (4,5) and possibly the first and second connecting portions (31,32) with a relative clearance that is such as to permit a relative angular displacement of these components in order to achieve a correct relative position of the components, and subsequently to fill the clearance with a fixing means in order to secure the components in this position.

4. A method according to one of the preceding claims,
characterised by manufacturing the housings (8,9) by stamping, bending and possibly pressing of a plate-shaped material.

5. A reaction rod for use in connecting a chassis (21) of a vehicle with a wheel axle housing (22) of the vehicle, where the reaction rod comprises
a rod-shaped central portion or rod (1) with two end portions, each with its first connecting portion (31,32),
two housings (2,3), which have been fabricated separately from the rod (1), each with its second connecting portion (33,34), and which are rigidly connected with the respective, first connecting portions (31,32), and each housing (2,3) has a through-going passage (4,5),
characterised in that the housings are manufactured by stamping and bending of a plate-shaped material.

6. A reaction rod according to claim 5,
characterised in that each housing is provided as a C-shaped hoop, the second connecting portion (33) comprising two halves (33a,33b) extending with a relative clearance (33c).

7. A jig for manufacturing a reaction rod for use in connecting a chassis (21) of a vehicle with a wheel axle housing (22) of the vehicle, where the reaction rod comprises
a rod-shaped central portion or rod (1) with two end portions, each with its first connecting portion (31,32),
two housings (2,3), each with its second connecting portion (33,34), which can be rigidly connected with the respective, first connecting portions (31,32), and each housing (2,3) has a through-going passage (4,5), and
two attachment pieces (8,9), each of which extends through its passage (4,5), and has attachment lugs (14,15), which on use of the reaction rod can be attached to the chassis (21) and the wheel axle housing (22) respectively,
where the distance between reference points (16,17) of the respective attachment lugs (14,15) establishes a functional length (F) of the reaction rod,
where the rod (1) and the housings (2,3) are initially assembled without being permanently interconnected, and the attachment pieces (8,9) are inserted in the respective housings (2,3),
characterised in that the jig (50) comprises a bottom (51) on which is mounted with an intermediate space a positioning device (52-55) for securing the respective attachment lugs (14,15), whereby the reference points (16,17) are kept at a relative distance corresponding to the functional length (F), and the rod (1) and the housings (2,3) can be attached to each other while thus secured.

8. A method for manufacturing a reaction rod for use in connecting a chassis (21) of a vehicle with a wheel axle housing (22) of the vehicle, where the reaction rod comprises
a rod-shaped central portion or rod (1) with two end portions, each with its first connecting portion (31,32),
two housings (2,3), each with its second connecting portion (33,34), which can be rigidly connected with the respective, first connecting portions (31,32), and each housing (2,3) has a through-going passage (4,5) with a first longitudinal axis (L1) extending through a central point of the passage's cross section, and
two attachment pieces (8,9), each of which extends through its passage (4,5), and which on use of the reaction rod can be attached to the chassis (21) and the wheel axle housing (22) respectively, where the attachment pieces (8,9) have a second longitudinal axis (L2) extending through a centre point of the attachment pieces' cross section,
where the distance between the reference points (16,17) of the respective attachment pieces (8,9) establishes a functional length (F) of the reaction rod,
where the rod (1) and the housings (2,3) are initially assembled without being permanently interconnected,
characterised by the following steps;
establishing the contour of each attachment piece (8,9) in the direction of the second longitudinal axis (L2),
analysing the contour of the attachment piece (8,9) and establishing the location of the centre point of the contour,
calculating the distance between the attachment piece's (8,9) reference point (16,17) and centre point, considered in the direction of the attachment piece (8,9) which coincides with the finished reaction rod's longitudinal direction,
mounting the rod (1) with the housings (2,3) in a jig with two insertion pieces, whose cross section is adapted to the cross section of the passages, and each of which has third longitudinal axes (L3), extending through the centre point of the respective insertion pieces' cross section, the insertion pieces being inserted in the respective passages,
adjusting the distance between the third longitudinal axes (L3) of the insertion pieces in the housings in such a manner that the distance between the third longitudinal axes (L3) corresponds to the distance between the second longitudinal axes (L2) when the reference points are at a relative distance corresponding to the functional length (F),
connecting the housings with the rod, and
inserting the attachment pieces in the respective passages.
